(19) United States
(12) Patent Application Publication
(10) Pub. No.: US 2024/0213584 A1
(43) Pub. Date: Jun. 27, 2024

(54) CYLINDRICAL CAN FOR SECONDARY CELLS

(71) Applicant: Northvolt AB, Stockholm (SE)

(72) Inventors: Koki INOUE, ENKÖPING (SE); Saurabh BIDARI, VÄSTERÅS (SE)

(21) Appl. No.: 18/390,132

(22) Filed: Dec. 20, 2023

(30) Foreign Application Priority Data
Dec. 23, 2022 (SE) 2251576-1

(51) Int. Cl. H01M 50/107; H01M 50/133; H01M 50/167

(52) U.S. Cl. CPC H01M 50/107; H01M 50/133; H01M 50/167

(57) ABSTRACT

This disclosure presents a cylindrical can (1) for a cylindrical secondary cell. The cylindrical can (1) extends along a longitudinal axis (LA) and comprises an opening (2) for jellyroll insertion, a top portion (10), a wall portion (20) and a transition area (15) between the top portion (10) and the wall portion (20). The wall portion (20) has a smaller thickness than the top portion (10), and the transition area (15) has a thickness which increases gradually from the wall portion (20) towards the top portion (10) by a slope value. The slope value is defined by a length of the transition area (15) with respect to a wall thickness change of the cylindrical can (1) in the transition area (15) and lies within the range of 5 to 120 over a length of at least 1.0 mm of the can.

### TECHNICAL FIELD

The present disclosure generally pertains to a cylindrical can for a cylindrical secondary cell, and a secondary cell for a secondary battery comprising the cylindrical can.

### BACKGROUND

Secondary batteries are becoming an important part in the movement towards electrification of transportation and renewable energy supply. Such batteries typically comprise a number of cells, often referred to as secondary cells.

A cylindrical secondary cell typically includes an electrode assembly arranged within a cylindrical casing in the form of a metal can. The metal can is first provided as a can with an opening at the top, through which the electrode assembly is inserted. Then, the can is preferably sealed off at the top by some kind of sealing assembly. When closing the opening of the can after insertion of the electrode assembly, the metal can is then compressed, or bent, which leads to so called bead formation. This is associated with undesired effects such as stress formation in the upper part of the metal can, which is also referred to as the beading region.

To overcome the issues related to beading, several variants of cylindrical cans have been developed over the years, all of them having certain drawbacks leading either to an excess usage of material or other inferior properties of the can. Based on the above, it is clear that there is room for improvements.

### SUMMARY

It is in view of the above considerations and others that the embodiments of the present invention have been made. The present disclosure aims at providing cylindrical cans for secondary cells that are efficient in manufacture and able to withstand the pressure exerted on the can when forming the secondary cells.

According to a first aspect, the present disclosure provides a cylindrical can for a cylindrical secondary cell. The cylindrical can extends along a longitudinal axis and comprises: an opening at a proximal end of the cylindrical can for jellyroll insertion, a top portion, a wall portion and a transition area between the top portion and the wall portion. The wall portion has a smaller thickness than the top portion, and the transition area has a thickness, which increases gradually from the wall portion towards the top portion by a slope value. The slope value is defined by a length of the transition area with respect to a wall thickness change of the cylindrical can in the transition area, where the length of the transition area extends in a direction parallel with the longitudinal axis of the cylindrical can, and where the thickness change of the cylindrical can occurs in a transverse direction with respect to the longitudinal axis of the cylindrical can. The slope value lies within the range of 5 to 120 over a length of at least 1.0 mm of the can.

A main advantage of the slope value in the transition area is to optimise the use of material. In particular, the amount of material used for the cylindrical can may be reduced in comparison with prior art examples. The slope value in the transition area represents a smooth and gradual increase in wall thickness from the wall portion to the top portion. This is better than an abrupt stepwise increase in wall thickness which is common in the art.

A further effect of the gradual thickness increase in the transition area is that stress concentrations are evened out during manufacturing of the secondary cell in which the cylindrical can is plastically deformed from an initially elongate cylinder shape with an open top, to a closed can. The thickness increase in the transition area, which is located just below a beading zone, ensures that the effects of beading does not cause the wall portion to bend when forces are applied during beading.

Further to the above, the reduced weight, as compared to inferior prior art examples, has a positive impact on the specific energy, or power, of the cell.

According to a second aspect, a secondary cell for a secondary battery is provided, comprising a cylindrical can according to the above, a jellyroll contained in the cylindrical can, and a cap assembly. The cylindrical can is beaded at the distal zone and/or the intermediate zone, Moreover, the cylindrical can is crimped at the proximal zone and/or the intermediate zone. The cap assembly is arranged between the beading zone and the crimp zone.

The above-described can for a cylindrical secondary cell may be provided for use in a vehicle battery for propelling a vehicle. The vehicle may for example be a fully electrically propelled vehicle or a hybrid vehicle.

### BRIEF DESCRIPTION OF THE DRAWINGS

The embodiments disclosed herein are illustrated by way of example, and not by way of limitation, in the figures of the accompanying drawings. Like reference numerals refer to corresponding parts throughout the drawings, in which

FIG. 1 schematically illustrates an open cylindrical can,

FIG. 2 schematically illustrates a cross-section of a part of the cylindrical can of FIG. 1, and

FIG. 3 schematically illustrates a cross-section of an upper part of the cylindrical can of FIG. 1.

### DETAILED DESCRIPTION

Embodiments of the present disclosure will now be described more fully hereinafter. The invention may, however, be embodied in many different forms and should not be construed as limited to the embodiments set forth herein; rather, these embodiments are provided by way of example so that this disclosure will be thorough and complete, and will fully convey the scope of the invention to those persons skilled in the art.

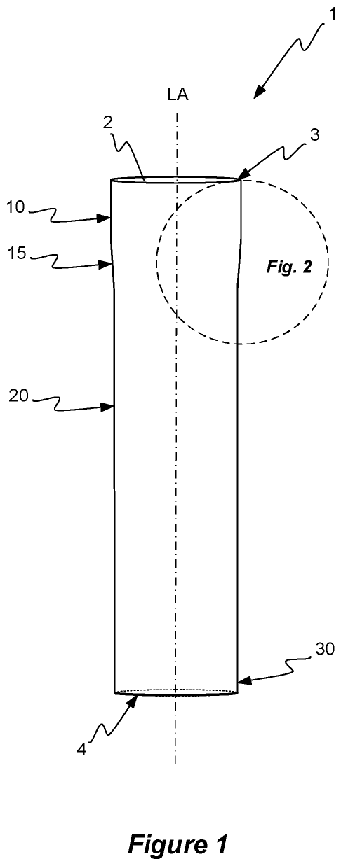

FIG. 1 illustrates a cylindrical can 1 for a cylindrical cell. The cylindrical can 1, which may also be referred to as a cylindrical case, extends along a longitudinal axis LA and has a proximal end 3 and a distal end 4. An opening 2 is provided at the proximal end 3 of the cylindrical can 1 for jellyroll insertion. In other words, the cylindrical can 1 is configured to house an electrode assembly (not shown), which may also be referred to as a jellyroll. Jellyrolls are known in the art. Likewise, the means of connecting the electrodes of the jellyroll to the relevant parts of the cell for it to work is also known in the art. Typically, the jellyroll is inserted through the opening 2 of the cylindrical can 1 in an open state of the cylindrical can 1, as shown in FIG. 1. The cylindrical can 1 is in its open state before jellyroll insertion. Before inserting the jellyroll, the upper part of the cylindrical can 1, near the opening 2, is wider than the remaining part of the cylindrical can 1. This is to enable safe insertion of the jellyroll without causing any damage to the jellyroll.

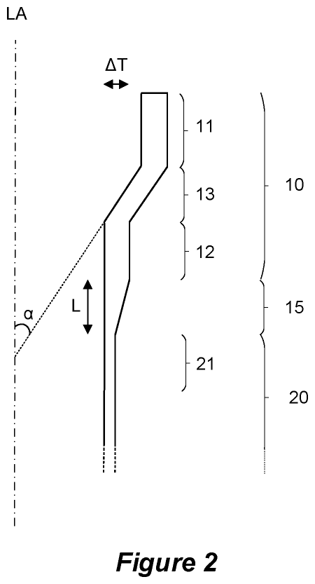

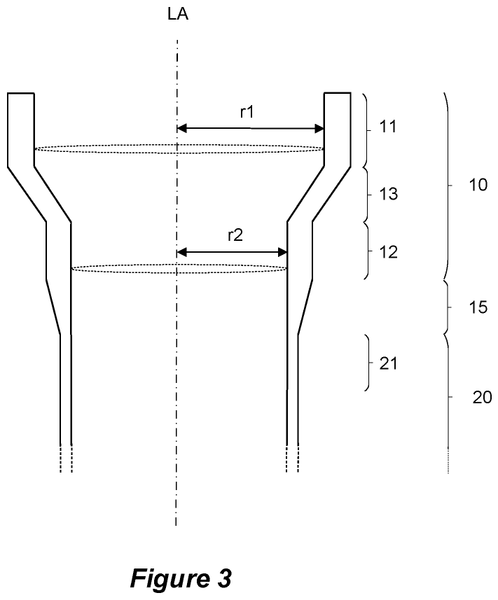

The cylindrical can 1, which is preferably made of metal, includes a top portion 10, a wall portion 20 and a transition area 15 between the top portion 10 and the wall portion 20. The transition area 15 may be described as an area connecting, or joining, the top portion 10 and the wall portion 20. Also, the transition area 15 may be described as having a tapered shape as seen in cross-section. The tapered shape of the transition area 15 is best described in relation to FIGS. 2 and 3 (see below). Moreover, the transition area 15 is seen as tapering from the top portion 10 towards the wall portion 20. However, it is preferably regarded as a thickening part of the cylindrical can 1, which transitions gradually rather than stepwise, from the wall portion 20 towards the top portion 10.

A main purpose of the gradually thickening transition area 15 is to create stability in the structure of the cylindrical can 1 when going from the open state as shown in FIG. 1 to a final, closed can (not shown), after the top portion has been folded centrally to enclose and contain the electrode assembly/jellyroll. Within the context of this description, the term “folded” may also be explained as “bent inwards” towards the longitudinal axis LA. The final closed can is to be used in a secondary battery assembly. The positioning of the transition area 15 is also partly related to the jellyroll height as well as the dimensions of a cap assembly, which forms an electrode connection in the secondary cell.

In a preferred embodiment, the top portion 10, the transition area 15 and the wall portion 20 are formed as an integral part. Since the cylindrical can 1 is configured to house a jellyroll, the cylindrical can 1 further has a bottom portion 30 at the distal end 4. Preferably, the top portion 10, the transition area 15, the wall portion 20 and the bottom portion 30 are formed as an integral part or unit. In general, the wall portion 20 represents the majority of the longitudinal length of the cylindrical can 1.

As illustrated schematically in FIGS. 2 and 3, the top portion 10 includes a cylindrical proximal zone 11 and a cylindrical distal zone 12. In particular, the proximal zone 11 faces the opening 2 of the cylindrical can 1 and the distal zone 12 faces the transition area 15. The cylindrical shape is accentuated by the dotted circles in FIG. 3. Each one of the proximal zone 11 and the distal zone 12 has an inner circumference and an outer circumference, respectively. In fact, all parts 10, 11, 12, 13, 15, 20, 30 described herein have an inner circumference and an outer circumference. The cylindrical can 1 has an inner diameter, which is defined by the inner circumference of the can. More specifically, the inner diameter is defined as two times the distance between the inner circumference and the longitudinal axis LA in the transverse direction of the can. This applies at every given point throughout the length of the cylindrical can 1. The distance between the inner circumference and the longitudinal axis LA in the transverse direction of the cylindrical can 1 may also be referred to as a radius.

With reference to FIG. 3, the inner circumference of the proximal zone 11 is distanced a first distance r1 in a transverse direction with respect to the longitudinal axis LA. Similarly, the inner circumference of the distal zone 12 is distanced a second distance r2 in a transverse direction with respect to the longitudinal axis LA. Before inserting the jellyroll into the cylindrical can 1, the first distance r1 is greater than the second distance r2. Put differently, the first distance r1 from the inner circumference of the cylindrical proximal zone 11 to the longitudinal axis LA in a transverse direction, is greater than the second distance r2 from the inner circumference of the cylindrical distal zone 12 to the longitudinal axis LA in the transverse direction. Moreover, the transverse direction may also be regarded as a direction perpendicular to the longitudinal axis LA.

The inner diameter of the cylindrical can 1 at the proximal zone 11 is defined as two times the first distance r1 between the inner circumference of the proximal zone 11 and the longitudinal axis LA. Correspondingly, the inner diameter of the cylindrical can 1 at the distal zone 12 is defined as two times the second distance r2 between the inner circumference of the distal zone 12 and the longitudinal axis LA. In other words, the radius r1 at the proximal zone 11 is larger than the radius r2 at the distal zone 12, when the cylindrical can 1 is in an open state.

In this disclosure, the longitudinal axis LA is to be interpreted as extending along the length of the cylindrical can 1, through a center point of the cylindrical can 1, such that the inner diameters (dotted circles in FIG. 3) of the cylindrical can 1 are concentric along the longitudinal axis LA.

An intermediate zone 13 is also provided in the top portion 10, arranged and extending between the proximal zone 11 and the distal zone 12. In an open state of the cylindrical can 1, as described and shown in the drawings, the intermediate zone 13 is directed away from the longitudinal axis LA of the cylindrical can 1, thereby increasing the inner diameter (and outer diameter) of the cylindrical can 1 in this region of the top portion 10. Moreover, the intermediate zone 13 may be described as being inclined an angle α with respect to the longitudinal axis LA. For instance, the angle α ranges between 1° and 4°, preferably between 2° and 3.5°, more preferably between 2.3° and 3.5°, and most preferred 3.3°.

Notably, each one of the cylindrical proximal zone 11, the intermediate zone 13 and the cylindrical distal zone 12 preferably have the same thickness, where the thickness is defined as the cross-sectional distance between the outer circumference and the inner circumference of the respective zone 11, 12, 13. Preferably, the intermediate zone 13 has an inner circumference and an outer circumference tapering between the respective inner and outer circumferences of the proximal zone 11 and the distal zone 12. This is schematically shown in FIGS. 2 and 3.

The distal zone 12 and a part of the intermediate zone 13 of the top portion 10 may also be referred to as a beading zone. Put differently, the distal zone 12 and a part of the intermediate zone 13 defines a beading zone. As will be understood from a manufacturing point of view below, the beading zone is the region of the cylindrical can 1 at which a beading knife comes into contact during beading of the cylindrical can 1. In FIG. 2, the top portion 10 is illustrated from a cross-sectional perspective and only one half side of the cylinder is shown. This is indicated by the dashed circle in FIG. 1. A full cross-section view of the upper part of the cylindrical can 1, i.e. the right part of FIG. 2 mirrored in the longitudinal axis LA, is shown in FIG. 3.

In reality, the inner diameter of the cylindrical can 1 at the distal zone 12 ranges between 20.50 and 20.65 mm, preferably between 20.55 and 20.60 mm, whereas the inner diameter of the cylindrical can 1 at the proximal zone 11 ranges between 20.75 and 20.90, preferably between 20.80 and 20.85 mm. As already indicated above, the relatively wider proximal zone 11 as compared to the distal zone 12 enables simplified jellyroll insertion. The inner diameter of the cylindrical can 1 is defined by the inner circumference of the cylindrical can 1. Correspondingly, the outer diameter of the cylindrical can 1 is defined by the outer circumference of the cylindrical can 1. Moreover, the inner diameter of the cylindrical can 1 is defined by the inner circumference as two times the distance between the inner circumference of the cylindrical can 1 and the longitudinal axis LA in the transverse direction.

The wall portion 20 has a relatively smaller thickness as compared to the top portion 10, and the transition area 15 has a thickness, which increases gradually from the wall portion 20 towards the top portion 10, between a proximal end 21 of the wall portion 20 and the distal zone 12 of the top portion 10. The transition area 15 has a length L, which is defined as a distance extending along the inner circumference of the cylindrical can 1, in a direction parallel with the longitudinal axis LA, between the proximal end 21 of the wall portion 20 and the distal zone 12 of the top portion 10. Put differently, the inner circumference of the cylindrical can 1 is substantially the same in the transition area 15, whereas the outer circumference of the cylindrical can 1 increases from the proximal end 21 of the wall portion 20 towards the distal zone 12 of the top portion 10. At the transition area 15, the outer circumference of the cylindrical can 1 may also be described as being tapering from the distal zone 12 towards the wall portion 20.

Preferably, the proximal zone 11, the distal zone 12 and the wall portion 20 are cylindrical in shape, meaning that they have a longitudinal extension which is substantially parallel to the longitudinal axis LA of the cylindrical can 1. In contrast, the intermediate zone 13 has a varying inner and outer diameter. The transition area 15 on the other hand has a fix inner diameter and a varying outer diameter which increases from near the wall portion 21 towards the distal zone 12 of the top portion 10.

In general, the thicknesses of the top portion 10, the wall portion 20 and the bottom portion 30, respectively, are substantially uniform, meaning that they do not have a varying thickness in the same manner as the transition area 15. Instead, in the transition area 15, the cylindrical can 1 exhibits a thickness change ΔT along the length L of the transition area 15, see FIG. 2. As opposed to the length definition, the thickness at the transition area 15 is instead defined as extending perpendicularly from the longitudinal axis LA, in a transverse direction from an inner circumference of the cylindrical can 1 to the other circumference of the cylindrical can 1. A minimal length L of the transition area 15 is between 0.5 to 1.5 mm, such as 1.0 mm. For instance, the length L of the transition area 15 may be up to 5.0 mm. However, there is no need for having an particularly long transition area 15. A length L of 1.0 mm is enough to achieve a smooth, edgeless transition between the wall portion 20 and the top portion 10 of the cylindrical can.

In the transition area 15, the outer diameter of the cylindrical can 1 ranges between 20.95 and 21.25, whereas the inner diameter is the same and ranges between 20.50 and 20.65 mm. Preferably, the inner diameter of the cylindrical can 1 in the transition area 15 is between 20.55 and 20.60 mm. Notably, the inner circumference of the wall portion 20 and the transition portion 15 is the same and extends perpendicularly from the longitudinal axis LA in a transverse direction, and the outer circumference of the cylindrical can 1 tapers towards the wall portion 20 at the transition area 15.

The gradual increase in thickness in the transition area 15 over the length L is hereby described by a slope value. The slope value is defined by the length L of the transition area 15 with respect to the wall thickness change ΔT of the cylindrical can 1 in the transition area 15. The relationship between the length and thickness change over the transition area 15 may be defined as a ratio between the length L of the transition area 15 and the thickness change ΔT of the cylindrical can 1 in the transition area 15.

As briefly mentioned, the length L of the transition area 15 extends in a direction parallel with the longitudinal axis LA of the cylindrical can, and the thickness change ΔT of the cylindrical can 1 occurs in a transverse direction with respect to the longitudinal axis LA of the cylindrical can 1. The transition area 15 extends over a length of at least 1.0 mm of the cylindrical can 1. Preferably, the transition area 15 extends over a length of between 1.0 to 3.0 mm of the cylindrical can 1, such as over a length of between 1.5 to 2.5 mm, and more preferably over a length of 2.0 mm. Moreover, the thickness change ΔT of the cylindrical can 1 in the transition area 15 ranges between 0.025 and 0.105 mm, between 0.025 and 0.085 mm, or between 0.025 and 0.045 mm.

An advantage of length and thickness dimensions in the transition area 15 is to ease out stress concentration caused during plastic deformation of the can when folded from an open can into a closed can of a cylindrical secondary cell. The term “folded” may also be referred to as “plastically deformed”. A further advantage is that, as opposed to having a cylindrical can 1 with an abrupt edge going from the wall portion to the top portion, the inventive concept addresses the problem of heavy weight batteries by reducing the weight of the cylindrical can, which indeed constitutes a great part of a secondary battery. Moreover, the reduced weight, as compared to inferior prior art examples, has a positive impact on the specific energy, or power, of the cell.

The slope value as defined above lies within the range of 5 to 120, such as 10 to 100, over a length of at least 1.0 mm of the can. Other suitable ranges of the slope value lies within 15 to 90, such as 30 to 80, or 50 to 70. See Table 1 for calculations of the slope value for different lengths L and wall thickness changes ΔT of the transition area 15.

TABLE 1
Calculation of different slope values in
the transition area of a cylindrical can

| | Thickness | |
|---|---|---|
| Length of | change in | |
| transition | transition area | Slope value |
| area (mm) | (mm) | (L/ΔT) |
| 1.0 | 0.025 | 40.000 |
| 1.0 | 0.035 | 28.571 |
| 1.0 | 0.045 | 22.222 |
| 1.0 | 0.065 | 15.385 |
| 1.0 | 0.085 | 11.765 |
| 1.0 | 0.105 | 9.524 |
| 1.5 | 0.025 | 60.000 |
| 1.5 | 0.035 | 42.857 |
| 1.5 | 0.045 | 33.333 |
| 1.5 | 0.065 | 23.077 |
| 1.5 | 0.085 | 17.647 |
| 1.5 | 0.105 | 14.286 |
| 2.0 | 0.025 | 80.000 |
| 2.0 | 0.035 | 57.143 |
| 2.0 | 0.045 | 44.444 |
| 2.0 | 0.065 | 30.769 |
| 2.0 | 0.085 | 23.529 |
| 2.0 | 0.105 | 19.048 |
| 2.5 | 0.025 | 100.000 |
| 2.5 | 0.035 | 71.429 |
| 2.5 | 0.045 | 55.556 |
| 2.5 | 0.065 | 38.462 |
| 2.5 | 0.085 | 29.412 |
| 2.5 | 0.105 | 23.810 |
| 3.0 | 0.025 | 120.000 |
| 3.0 | 0.035 | 85.714 |
| 3.0 | 0.045 | 66.667 |
| 3.0 | 0.065 | 46.154 |
| 3.0 | 0.085 | 35.294 |
| 3.0 | 0.105 | 28.571 |

A secondary cell having a cylindrical can according to what has been described above and including a jellyroll may also be provided. To form the secondary cell, the cylindrical can 1 is shaped according to a series of folding steps. In a first step towards forming the secondary cell, the cylindrical can 1 is provided with an open top where it has an outer diameter, or outer circumference, of between 21.35 and 21.45 at the top portion 10, preferably 21.40 mm and a total length of between 73.15 and 73.25, preferably 73.20 mm. Notably, the initial length of the cylindrical can 1 (when open as shown in FIG. 1) is measured as the longitudinal distance from the proximal end 3 at the top portion 10 of the cylindrical can 1 to the distal end 4 at the bottom portion 30 of the cylindrical can 1. After providing an open top cylindrical can 1 according to the above, a jellyroll is inserted via the opening 2 of the cylindrical can 1. Then, after a series of steps including swaging, crimping and beading of the cylindrical can 1 at the top portion 10, the final dimensions of the cylindrical can 1 end up lying within 20.95 and 21.05 mm in diameter, corresponding to the outer diameter of the secondary cell, and within 69.80 and 70.20 in final length.

As mentioned, before inserting the jellyroll into the cylindrical can 1, the first distance r1 from the inner circumference of the cylindrical proximal zone 11 to the longitudinal axis LA is greater than the second distance r2 from the inner circumference of the cylindrical distal zone 12 to the longitudinal axis LA. However, after swaging, the first distance r1 will be smaller than the second distance r2.

Preferably, the proximal zone 11 of the top portion 10 extends in a direction parallel to the longitudinal axis LA between 0 and 3.2 mm, more preferably between 0 and 2.2 mm and most preferred between 0 and 2.7 mm from below the opening 2 of the cylindrical can. Before swaging, i.e. before inserting the jellyroll, the proximal zone 11 of the top portion 10 preferably has an inner diameter of 20.83 mm, and after swaging, it will have an inner diameter of 20.30 mm.

The intermediate zone 13 of the top portion 10 extends below the proximal zone 11 between 2.2 to 3.2 mm and 4.2 to 5.2 mm from the opening 2 of the cylindrical can. Below the intermediate zone 13 of the top portion 10, starting from the distal zone 12, the cylindrical can 1 preferably has an inner diameter of 20.60 mm. The distal zone 12 is located and extends below the intermediate zone 13 between 4.2 to 5.2 mm and 6.3 to 7.3 mm from the opening 2 of the cylindrical can 1. Finally, the transition area 15 extends below the intermediate zone 13 between 6.3 to 7.3 mm and 8.3 to 9.3 mm from the opening 2 of the cylindrical can 1.

In general, thicker walls of the cylindrical can 1 are required at the top portion 10 to withstand the effects of beading and crimping, as well as at the bottom portion 30 where jellyroll connection takes place. For instance, the bottom portion 30 may have a thickness of 0.30 mm. At the top of the cylindrical can 1, the thickness is increased a certain distance below the beading zone to avoid the beading causing the can wall to bend.

As briefly mentioned, the beading zone may be defined as a part of the top portion 10 which includes the distal zone 12 and a part of the intermediate zone 13 facing the distal zone 12. Optionally, the beading zone may also be located either at the distal zone 12 or at a part of the intermediate zone 13 facing the distal zone 12. Moreover, a crimp zone may be defined as a part of the top portion 10 which includes the proximal zone 11 and a part of the intermediate zone 13 facing the proximal zone 11. Optionally, the crimp zone may also be located either at the proximal zone 11 or at a part of the intermediate zone 13 facing the proximal zone 11. During manufacturing, the cylindrical can 1 is crimped in the crimp zone and beaded in the beading zone.

A secondary cell (not shown) may comprise a cylindrical can according to the above, a jellyroll contained in the cylindrical can 1, as well as a cap assembly (not shown). Cap assemblies are commonly known in the art. A cap assembly commonly comprises a Current Interruption Device (CID), a vent, an inner and outer gasket and a top cap but can be designed in many different ways. In the secondary cell, the cylindrical can 1 is beaded at the distal zone 12 and/or the intermediate zone 13, and crimped at the proximal zone 11 and/or the intermediate zone 13. Moreover, the cap assembly is located at the proximal end 3 of the cylindrical can 1, and arranged between the beading zone and the crimp zone.

Put differently, the top portion 10 of the open cylindrical can 1 is folded in ways described above, to enclose and contain a jellyroll which is inserted through the opening 2 of the can 1. The top portion 10, such as the proximal zone 11 and/or the intermediate zone 13 is folded over the cap assembly to close the opening 2 of the cylindrical can 1, by crimping. For instance, the folding of the cylindrical can 1 at the top portion 10 over the cap assembly, to close the opening 2 of the cylindrical can 1 may be referred to as a crimping process. After insertion of the jellyroll and before arranging the cap assembly in the cylindrical can 1, the can is at first beaded at the beading zone, i.e. at the distal zone 12 and/or the intermediate zone 13. This way, the cap assembly will be arranged, or trapped, between the distal zone 12 and the proximal zone 11 when the cylindrical can 1 is closed.

According to the inventive concept, the increase in thickness in the transition area 15 is gradual, rather than abrupt (stepwise). This way, stress concentrations during plastic deformation are avoided in the beading zone. The thickness is gradual within the meaning that there is no abrupt edge at the interface between the wall portion 10 and the top portion 10. The transition area 15 is not to be confused with a merely tapering area. Instead, with the slope value as described above, a seamless or edgeless transition between the top portion 10 and the wall portion 10 is ensured. A way of describing the terms ‘seamless’ or ‘edgeless’ may be through a curvature at a junction between the top portion and the transition area having an endless radius, i.e. not as shown in FIG. 2 which is a mere schematic representation to highlight the different constituents of the upper part of the cylindrical can 1.

Further, the invention has mainly been described with reference to a few embodiments. However, as is readily understood by a person skilled in the art, other embodiments than the ones disclosed above are equally possible within the scope of the invention, as defined by the appended claims.

In the claims, the term “comprises/comprising” does not exclude the presence of other elements or steps. Additionally, although individual features may be included in different claims, these may possibly advantageously be combined, and the inclusion in different claims does not imply that a combination of features is not feasible and/or advantageous. In addition, singular references do not exclude a plurality. The terms “a”, “an”, “first”, “second” etc. do not preclude a plurality. Reference signs in the claims are provided merely as a clarifying example and shall not be construed as limiting the scope of the claims in any way.

1-11. (canceled)

12. A cylindrical can for a cylindrical secondary cell, said cylindrical can extending along a longitudinal axis (LA), wherein the cylindrical can (1) comprises:
an opening (2) at a proximal end (3) of the cylindrical can (1) for jellyroll insertion,
a top portion (10),
a wall portion (20), and
a transition area (15) between the top portion (10) and the wall portion (20),
wherein:
the wall portion (20) has a smaller thickness than the top portion (10),
the transition area (15) has a thickness which increases gradually from the wall portion (20) towards the top portion (10) by a slope value,
the slope value is defined by a length (L) of the transition area (15) with respect to a wall thickness change (ΔT) of the cylindrical can (1) in the transition area (15),
the length (L) of the transition area (15) extends in a direction parallel with the longitudinal axis (LA) of the cylindrical can (1),
the thickness change of the cylindrical can (1) occurs in a transverse direction with respect to the longitudinal axis (LA) of the cylindrical can (1), and
the slope value lies within the range of 5 to 120 over a length of at least 1.0 mm of the can.

13. The cylindrical can according to claim 12, wherein the slope value lies within the range of 10 to 100.

14. The cylindrical can according to claim 13, wherein the transition area (15) extends over a length of 1.0 to 3.0 mm of the cylindrical can (1).

15. The cylindrical can according to claim 12, wherein the slope value lies within the range of 15 to 90.

16. The cylindrical can according to claim 12, wherein the slope value lies within the range of 30 to 80, or 50 to 70.

17. The cylindrical can according to claim 12, wherein the slope value lies within the range of 50 to 70.

18. The cylindrical can according to claim 12, wherein the transition area (15) extends over a length of 1.0 to 3.0 mm of the cylindrical can (1).

19. The cylindrical can according to claim 12, wherein the transition area (15) extends over a length of 1.5 to 2.5 mm of the cylindrical can (1).

20. The cylindrical can according to claim 12, wherein the transition area (15) extends over a length of 2.0 mm of the cylindrical can (1).

21. The cylindrical can according to claim 12, wherein the thickness change of the cylindrical can (1) in the transition area (15) ranges between 0.025 and 0.105 mm.

22. The cylindrical can according to claim 11, wherein the thickness change of the cylindrical can (1) in the transition area (15) ranges between 0.025 and 0.085 mm.

23. The cylindrical can according to claim 12, wherein the thickness change of the cylindrical can (1) in the transition area (15) ranges between 0.025 and 0.045.

24. The cylindrical can according to claim 12, wherein the top portion (10) comprises a cylindrical proximal zone (11) facing the proximal end (3) of the cylindrical can (1), and a cylindrical distal zone (12), wherein the cylindrical distal zone (12) defines a beading zone.

25. The cylindrical can according to claim 24, wherein the beading zone is located and extends in a direction parallel to the longitudinal axis (LA) between 4.2 to 5.2 mm and 6.3 to 7.3 mm from the opening (2) of the cylindrical can (1).

26. The cylindrical can according to claim 25, wherein the transition area (15) is located below the beading zone and extends at a distance of between 6.3 to 7.3 mm and 8.3 to 9.3 mm from the opening (2) of the cylindrical can (1).

27. The cylindrical can according to claim 24, wherein the transition area (15) is located below the beading zone and extends at a distance of between 6.3 to 7.3 mm and 8.3 to 9.3 mm from the opening (2) of the cylindrical can (1).

28. The cylindrical can according to claim 12, further comprising a bottom portion (30) at a distal end (4) of the cylindrical can (1), wherein the wall portion (20) extends between the top portion (10) and the bottom portion (30).

29. The cylindrical can according to claim 28, wherein the bottom portion (30) has a thickness of 0.30 mm.

30. The cylindrical can according to claim 28, wherein the respective thicknesses of the top portion (10), the bottom portion (30) and the wall portion (20) are substantially uniform.

31. A secondary cell for a secondary battery, comprising:
the cylindrical can (1) according to claim 11,
a jellyroll contained in the cylindrical can (1), and
a cap assembly,
wherein:
the cylindrical can (1) is beaded at the distal zone (12) and/or the intermediate zone (13),
the cylindrical can (1) is crimped at the proximal zone (11) and/or the intermediate zone (13), and
the cap assembly is arranged between the beading zone and the crimp zone.
